(19) United States
(12) Patent Application Publication
(10) Pub. No.: US 2004/0175157 A1
(43) Pub. Date: Sep. 9, 2004

(54) Process for, concurrently, storing and accessing video data for different requesters, reading out different parts and having different startings times; and a process for, concurrently, storing and accessing multiple data files on the same storage medium for different requesters, reading out different parts and having different starting times

(76) Inventor: Frank Wagner Johnson, Beulah, MI (US)

Correspondence Address: Frank W. Johnson, 5785 Van Deman Place, POB 229, Beulah, MI, 49617, US

(21) Appl. No.: 10/382,557

(22) Filed: Mar. 7, 2003

(51) Int. Cl. H04N 5/781

(52) U.S. Cl. 386/125; 386/126

(57) ABSTRACT

A data accessing process with multiple read pick-up heads and/or multiple read/write heads and, where each head along with its independent control circuit can independently access the same data, concurrently, and read out different parts at the same or different times. The most important fields for my multiple, concurrent, separate access process are DVD, LAN and other storage systems, and Internet servers where data that is frequently accessed and often long, so that the server is tied up for long periods of time. THE PROBLEM THIS PROCESS IS MEANT TO ADDRESS IS, SIMPLY, CONCURRENT, MULTIPLE REQUESTS FOR PARTS OR ALL OF THE SAME DATA. This patent also addresses three other problems: the process of controlling the multiple pick-up heads, the location and the arrangement of the pick-ups, and the design of the pick-ups, such that they can be arranged as closely as possible, thus increasing the number of pick-up heads per disc.

### BACKGROUND OF THE INVENTION

The field of endeavor of this invention is in the process of storing and retrieving data.

Historically, virtually all storage systems were either buffers or sequentially stored files. But even the buffers were sequential. You could only access the buffer from one source at a time. But if you wanted another access, you had to wait until the first request was filled. Two main embodiments of my new process will be on large video files, and data files on various disc drives. These different embodiments are very similar but differ in detail.

LARGE VIDEO FILES: Currently, the cheapest, easiest, and most accurate storage of video data is on DVD (digital video discs). Current DVD players provide one output. Two or more simultaneous accesses may be obtained by simply dividing the output with or without amplification, and sending it to multiple destinations. The destination network must have megabit bandwidth for timely transmission. A ten megabit/second transmission of 120 minutes (7,200 seconds) would require the storage and transmission of 72,000 megabits (72 gigabits or about 5 gigabit with compression). To send 5 gigabits, even by DSL, over a twisted pair of wires as routed packets, is possible, but very expensive, and very slow.

For these practical reasons most DVD movies distributed by networks will go over cable, fiberoptic cables, or high frequency wireless. Using higher frequencies, one physical coaxial cable could be capable of transmitting around 200 video channels simultaneously. With a fiberoptic distribution system to a coaxial cable “last mile”, you could distribute tens of thousands of different channels simultaneously. The problem, for DVDs, my process aims to solve is that of MANY SEPARATE DIFFERENTLY TIMED REQUESTS FOR THE SAME MOVIE.

OTHER DATA FILES: Most non-movie data storage systems, however, are on various disc drives. There is a possible overlap, but in current practice, the DVD drives are predominantly radial actuators that move from the center of the disc out, while most of the disc drive actuators are pivoted in and out from a pivot outside of the area of the disc. The radial actuators are predominantly screw type and mechanically they have slow access times. This is because DVD files are very large and meant to be read from beginning to end without stopping or the need for rapid access time. Disc files on the other hand may be very large but need rapid access time, so they use predominantly pivoted actuators with tracking controls.

The problem for large files is: the disc drive is unavailable to other requesters until the file has been completely down loaded. To solve this problem the current state of the arts provides inelegant, complex, and expensive solutions. For example, the data can be transferred to different buffers, each one of which could be accessed partially and started at a different time. These buffers would be very, very large (5-72 gigabits) or each separate request would take control of a separate disc drive. This would be complex and very expensive. The problem this process is meant to solve is MULTIPLE CONCURRENT ACCESSES TO THE SAME DATA. This data, for example, could be a data file of different bank accounts that different customers wanted to access at about the same time. My storage and retrieval process would allow all of them to do it, concurrently, with minimal waiting times.

CURRENT STATE OF THE ART, VIDEO: You can have multiple players with multiple disc of the same movie, multiple players that can change discs according to demand, or transfer the movie to a hard disc drive, where you will have the same access problems, but more complex electronic solution possible. With a high speed disc drive you can sequentially access and move different parts of the movie to different buffers where it can be fed to the customer in their proper sequence and without time lapses or overwrites. These buffers will then contain the movie (or other large data file) with different starting times. You can even manipulate these buffers so that the different buffers start at defined intervals (such as 5 minutes) so that many customers can access at the same time the different start time buffers. All this you can do with current technology. But this is complex and expensive.

CURRENT STATE OF THE ARTS; OTHER DATA FILES: You have similar problems with web servers, LANs, and other repositories of data and programs, where you have large number of requests for the same file, and these requests will que up and subsequent request will be unfilled. This is particularly true for video files. My data access process allows you to transmit from the DVD disc or disc drives for servers and other rotating storage media directly to the requester; and it is much easier, faster and, cheaper.

PRIOR STATE OF THE ART: Because DVDs, and most permanent storage devises are electromechanical in their control systems, the mechanical part gives SLOW access times, but once the sensor is in place RAPID access rates. Both access times and access rates are increased by higher revolutions/minute of the rotating medium. But average access time is still more than ½ of one revolution. There are many patents addressing access time:

Cornaby, U.S. Pat. No. 5,355,486 395/650 for example has two actuators and arranges one actuator to store and access data in increasing values of the cylinder addresses, while the second actuator stores and access the data in decreasing values of the cylinder addresses. This shortens the physical distance between successive data and thus lowers the access time. The abstract of the patent states “dual actuators . . . a means for assigning task stored in the registers in the queue to a first actuator of the dual actuators in the sequence of increasing value of the cylinder addresses of tasks stored the register in the queue and a second means for assigning tasks stored the queue to a second actuator of the dual actuators in the sequence of decreasing value of the cylinder addresses of the task stored in the registers in the queue.” The background of the patent states “ . . . select which actuator should be assigned a specific task so as to minimize the amount of travel to start the next task assigned to the actuator.” This again shows that the patent is about access time and not my process for multiple concurrent accesses. Again:

Claims 1-20 all start with “The task assigning system . . . ”

Claim 21 “The method of assigning tasks . . . ”

Claim 22 “ . . . Routine for removing task registers.”

Claim 23 “ . . . routine for assigning a new task . . . ”

Claim 24 “ . . . routine for assigning a new task . . . ”

All of these claims involve reducing access time and it is clear from the claims that the purpose of the invention was access time and not simultaneous access to the same data.

Hon, U.S. Pat. No. 4,490,810, 364/900, claim 17 and 18, claims multiple pickup heads and control unit for their particular game and data retrieval system. They do not discuss prior art of multiple pickups and control systems, and claim it only for their particular applications. The Hon patent applied only to laser video discs. Because Hon has multiple independently controlled heads, they are clearly the nearest Prior Art. Hon has three implementations: One a catalogue, one a learning program, and one an interactive game or lesson. In all three they were laser discs, and the discs had INDEPENDENT CIRCULAR TRACKS. For anything other than short files, changing between concentric circular tracks is very difficult because of lack of the tracking systems found on modern SPIRAL track discs. Further, each of the multiple pick-ups was limited to a section of the laser disc.

I, therefore, consider my process a dramatic improvement in multiple accessing video and disc data.

In two subsequent patents (assigned to Conner Peripherals, Inc., San Jose, Calif., Cornaby U.S. Pat. No. 5,355,486, and Squires, et al U.S. Pat. No. 5,610,8080) both containing two pickups, all claims refer to controller systems or assigning tasks. There was no claim for two heads.

A prior patent, Johnson, et al U.S. Pat. No. 4,667,258 is a mechanical system for rotating multiple heads into read/write position for different sized and differently formatted discs. There are 41 structural and mechanical claims but no claim for multiple heads. It is clear their claim was for a disc drive that could accommodate different discs formats. And, in fact there are several patents with two pickups prior to this patent. Thus it seems that the idea of two or more pickups was considered prior art.

Altman, U.S. Pat. No. 4,386,375 uses two pickups 180 degrees apart on a conventional circular recording medium for TV signals. It too makes no claim as to the number of pickups, but show 2 in its diagram.

My access process is not about shorter access time, but about, concomitant, multiple different accesses of the same stored data, possible, with different starting times If the data file in not very large, and there are not a large number of requests, conventional sequential systems work well. If there is only one request for access to a huge (multimillion) data file conventional sequential system works, but not too well, because you are asking for millions of sequential data files that have to be stored and sent out at the speed of the connection and then reassembled. Since the transmission systems for video and most other multi-megabyt files will be coaxial cable, fiberoptic cable, or wireless, and not twisted pairs, my process for data access is far cheaper and much more convenient.

NEW and NON-OBVIOUS: My process for accessing the same data file CONCURRENTLY with independent start times and accessing different parts of the whole file by different customers through separate transducers, separate control systems, and separate distribution channels rather than sequentially is far more effective, than simple sequential access. Like all really good, new, inventions, it seems obvious after you have thought of it, but not before. For example, an article in the most recent issue of IEEE's Computer magazine by Keeton et al, “PCT-W E-Commerce Benchmark Evaluation”, the benchmark sidebar states “ . . . and expresses performance in the NUMBER OF WEB INTERACTIONS PER SECOND by the server.” Since, clearly, under my process for multiple accesses to the same data, the through-put process may be increased by a factor of 5 or 10, or even more. In my not very extensive reading in the field, I have never come across any reference to improved through-put from a process of multiple independent accesses.

### BRIEF SUMMARY OF THE INVENTION

My process will store and read, concurrently, multiple data files on the same storage medium for different requesters, reading out different parts, and at possibly different start times. My process consists of having many identical pickup systems on the same DVD player or other rotating storage medium, such as servers. We restrict it to rotating storage medium, as it is difficult to have multiple heads on a non-rotating medium. There would be, none (DVD) or one or more (for other storage medium) write transducer, and many independently controlled read-only, or read/write heads. In some configurations all heads would be read/write.

There can be many pick-up arms arranged radially around the center of the rotating drive, (mostly DVD), or pivoting arms with pick-up and control systems arranged radially, with the pivots outside of the disc area itself.

DVD: When queried, the control system takes control the next available read-only head, starts the movie and sends it out to the customer. If there is another request the control system assigns another read-only head. Every successive request is assigned a head, including ones that are available because their read has been completed. If the all heads are busy, the system will determine when the next head is available, and ask the customer if he wants to wait, try another choice, or stop.

SERVERS and OTHER ROTATING STORAGE MEDIUM: In the case of other rotating (usually platter) medium, with repeated different demands for the same data, you would have one or multiple read/write head or one write head and multiple read heads. These storage media would probably have pivoting heads with individual actuator motors arranged in a circle outside of the platter area. The more the individual actuator motors are miniaturized, the more heads that can be located around the periphery of the disc. Various configurations are under study.

The pick-ups and storage medium can be magnetic, optical, or any other storage technology that lends itself to multiple, independently controlled heads and control circuits.

It would, for example, be very difficult to do with a tape drive, as you would have to store long sections of the tape between the different read/write heads. But other configurations of this process for, concurrent, multiple, independent, read/write access to different storage medium are possible and are claimed in this patent.

### DETAILED DESCRIPTION OF THE INVENTION

The essence of the process is of using multiple heads reading and writing to the same disc at the same time, though on different parts of the track. Some of the possible embodiments are listed below:

LARGE VIDEO FILES, DVD: In the DVD format, the pick-up heads control track's are arranged radially with a screw drive and control circuits, primarily because accurate tracking takes precedence over quick access time. In my embodiment the mechanism must be narrower toward the center of the disc as there is less room, and more space is available toward the periphery of the drive. I am developing some of these ideas further, but prefer to out-source these further improvement to experts in video pick-up and video player firms when the concept is patented. I see no other way to proceed without patent protection. The circuit control circuits are even more easily constructed, involving video requests, options (wait for next head?, wait predetermined time?) Further, the access circuits depend on how many radial heads can be designed for each player.

OTHER DATA FILES: For other data files my process will use multiple heads arranged on pivots spaced around the edge of the data disc, or other spatial arrangements. These also are best developed by experts in the disc drive field, which would be impossible without patent protection for the basic process of multiple, independent, concurrent, access of different data on different locations of the same track.

PICK-UP ARM: The pick-up arms are located on conventional pivots. If large a number of arms are used they will overlap, because of the large area covered by each arm. If, however the arms are thin and slanted down or up about 30 degrees to the disc surfaces, they will not physically collide, though their coverage area overlap, and thus you can mount many more heads around the periphery of the disc in the preferred system. The virtue of this arrangement is that many more arms with their transducers can be mounted around the periphery of the disc. The circumference of the 3½″ disc is about 10″. You should be able to get about 20 arm and disc assemblies around the periphery of the disc. In time this too may be increased, but it is doubtful that any more than 20 would be economic. If you double the number of pickups per disc from 20 to 40, the average total cost/pickup will be about the same so you might as well use two storage systems.

I claim:

1) A process for, concurrently, storing and accessing video data for different requester, reading out different parts, and having different starting times and where multiple users can access the same data concurrently
a) One embodiment of my, concurrent, multiple access process, in DVD and other medium, where current practice is a single screw type access arm, of an arrangement of multiple screw type, read-only transducers arranged radially around the drive spindle.
b) An embodiment of my, concurrent, multiple access process, in disc drives, and other storage medium, where these transducers will be placed on pivots arranged in a circle around the spindle beyond the disc area, and the transducer will be read or read/write, or there may be the only one transducer to feed in any signal, where the data will not to be changed except by the owner of the disc drive.
c) The multiple disc drives may be multiple, two sided, RAID, or other physical arrangements.
d) The necessary control circuits, for independent control and access to the different read or read/write heads, concurrently.

2) Transducers arms for the arrangements of the arms where the pivots are in a circle beyond the disc area where the transducer arms with the transducers will be as thin as possible and will be TILTED TOWARD THE DISC SURFACE AT AROUND A 30 DEGREE ANGLE FROM THEIR PIVOT so that though the coverage areas overlap, but neither the transducers nor the arms will physically collide.
